(19) United States
(12) Patent Application Publication
(10) Pub. No.: US 2013/0232235 A1
(43) Pub. Date: Sep. 5, 2013

(54) METHOD, DEVICE AND SYSTEM FOR REMOTE SERVER MANAGING WIRELESS TERMINAL

(71) Applicant: Xiaoliang Ma, Shenzhen City (CN)

(72) Inventor: Xiaoliang Ma, Shenzhen City (CN)

(73) Assignee: ZTE CORPORATION, Shenzhen City, Guangdong (CN)

(21) Appl. No.: 13/885,087

(22) PCT Filed: Nov. 2, 2011
(86) PCT No.: PCT/CN2011/081687

§ 371 Date: May 13, 2013

(51) Int. Cl. H04W 24/02

(52) U.S. Cl. CPC H04W 24/02
USPC 709/219

(57) ABSTRACT

A method for managing a wireless terminal by a remote server, wherein the remote server transmits to the wireless terminal a request for acquiring the parameter information of the wireless terminal; and the wireless terminal transmits the corresponding parameter information in a preset management information base (MIB) in the wireless terminal to the remote server according to the request transmitted by the remote server. Also disclosed are a remote server, a wireless terminal, and a system for managing the wireless terminal by the remote server.

### TECHNICAL FIELD

The present document relates to a technique of wireless terminal management in the wireless network, and particularly, to a method, device and system for a remote server managing a wireless terminal.

### BACKGROUND OF THE RELATED ART

With the development of the wireless network technology, a way of supporting mobile terminals (e.g. an intelligent phone) or computers to surf the Internet through wireless terminals such as the 3rd-generation mobile communication technology (3G) data card or MiFi products and so on has been adopted by the majority of users. Since a wireless terminal is small and exquisite and easy to carry, it enables the users to select a place for netsurfing more flexibly, and thus a way of surfing on a wireless internet is extensively used in the business area and household.

However, at the present, the wireless terminal cannot send its own configuration information and operating state to a remote server, and the remote server also cannot configure and manage the wireless terminal, thus, a network administrator fails to know the configuration and operation status of the wireless terminal through the remote server, and also fails to make statistics and analysis on status of the wireless terminal logging on the network. Moreover, when a user who uses the wireless terminal and network terminal to surf the Internet meets a network configuration problem, the network administrator cannot implement a technical support by the remote server configuring on the wireless terminal, which causes that the problem of the user cannot be solved in time.

### SUMMARY OF THE INVENTION

In view of this, the main object of the present document is to provide a method, device and system for a remote server managing a wireless terminal, which can implement an management on the wireless terminal by the remote server.

In order to achieve the foregoing objects, the technical scheme of the present document is implemented as follows.

The present document discloses a method for a remote server managing a wireless terminal, which comprises:

the remote server sending a request for acquiring parameter information of the wireless terminal to the wireless terminal;

the wireless terminal sending corresponding parameter information in a Management Information Base (MIB) preset in the wireless terminal to the remote server according to the request sent by the remote server.

Preferably, the remote server sending a request for acquiring information of the wireless terminal to the wireless terminal is:

the remote server sending the request for acquiring the information of the wireless terminal to the wireless terminal according to a set time interval;

or, the remote server sending the request for acquiring the information of the wireless terminal to the wireless terminal according to a received acquisition command.

Preferably, before the step of the remote server sending a request for acquiring information of the wireless terminal to the wireless terminal, the method further comprises:

when an operation of setting occurs on the wireless terminal, the wireless terminal sending an update notification to the remote server;

correspondingly, the remote server sending a request for acquiring information of the wireless terminal to the wireless terminal is: the remote server sending the request for acquiring the information of the wireless terminal to the wireless terminal according to the update notification sent by the wireless terminal.

Preferably, the MIB comprises: a standard Object Identifier (OID) and an extended OID.

The present document discloses a method for a remote server managing a wireless terminal, which comprises:

a network terminal sending a request for setting parameter information of the wireless terminal to the remote server;

the remote server converting a received request and sending the converted request to wireless terminal;

the wireless terminal setting corresponding parameter information in an MIB preset in the wireless terminal to according to the received request.

The present document discloses a method for a remote server managing a wireless terminal, which comprises:

when the wireless terminal is in a disconnect network state, the wireless terminal setting parameter information within a Node Value (NV) according to a request for setting parameter information of the wireless terminal sent by a network terminal;

when the wireless terminal is in a log-in network state, the wireless terminal sending an update notification to the remote server, and the update notification carrying changed contents of the parameter information within the NV;

the remote server setting corresponding parameter information in an MIB preset in the wireless terminal according to the update notification, to make parameter information within an OID of the MIB consistent with the parameter information within the NV.

Preferably, the wireless terminal sending an update notification to the remote server is: when the wireless terminal logs on a network, the wireless terminal sending the update notification to the remote server.

The present document discloses a remote server, which comprises:

an acquisition request sending unit, configured to: send a request for acquiring parameter information of a wireless terminal to the wireless terminal;

a setting request sending unit, configured to: perform a form conversion on a request for setting the parameter information of the wireless terminal sent by a network terminal and send the converted request to the wireless terminal;

an MIB setting unit, configured to: set corresponding parameter information in an MIB preset in the wireless terminal according to an update notification sent by the wireless terminal, to make parameter information within an OID of the MIB consistent with parameter information within an NV.

Preferably, the acquisition request sending unit comprises:

a first sending unit, configured to: send the request for acquiring the information of the wireless terminal to the wireless terminal according to a set time interval;

a second sending unit, configured to: send the request for acquiring the information of the wireless terminal to the wireless terminal according to a received acquisition command;

a third sending unit, configured to: send the request for acquiring the information of the wireless terminal to the wireless terminal according to the update notification sent by the wireless terminal.

The present document discloses a wireless terminal, which comprises: an acquisition request receiving unit and a parameter information sending unit, wherein,

the acquisition request receiving unit is configured to: receive an acquisition request sent by a remote server;

the parameter information sending unit is configured to: send corresponding parameter information in an MIB preset in the wireless terminal to the remote server according to the acquisition request sent by the remote server.

Preferably, the wireless terminal further comprises:

an update notification sending unit, configured to: when an operation of setting occurs on the wireless terminal, send an update notification to the remote server.

Preferably, the wireless terminal further comprises:

a parameter information setting unit, configured to: set the corresponding parameter information in the MIB preset in the wireless terminal according to a received request;

wherein the remote server performs a form conversion on a received request for setting parameter information of the wireless terminal sent by a network terminal and sends the converted request to the wireless terminal.

Preferably, the wireless terminal further comprises:

an NV setting unit, configured to: when the wireless terminal is in a disconnect network state, according to the request for setting the parameter information of the wireless terminal sent by the network terminal, set parameter information within a Node Value (NV);

the update notification sending unit is further configured to: when the wireless terminal is in a log-in network state, send an update notification to the remote server, and the update notification includes changed contents of the parameter information within the NV.

The present document discloses a system for a remote server managing a wireless terminal, which comprises: the remote server and at least one wireless terminal, wherein,

the remote server is configured to: send a request for acquiring parameter information of the wireless terminal to the wireless terminal; perform a form conversion on a request for setting the parameter information of the wireless terminal sent by a network terminal and send the converted request to the wireless terminal; and set corresponding parameter information in an MIB preset in the wireless terminal according to an update notification sent by the wireless terminal, to make parameter information within an OID of the MIB consistent with parameter information within an NV;

the wireless terminal is configured to: receive an acquisition request sent by the remote server; and send the corresponding parameter information in the MIB preset in the wireless terminal to the remote server according to a received acquisition request.

Alternatively, the wireless terminal is further configured to: when an operation of setting occurs, send the update notification to the remote server.

Alternatively, the wireless terminal is further configured to: set the corresponding parameter information in the MIB preset in the wireless terminal according to a received request; wherein the remote server performs a form conversion on the received request for setting the parameter information of the wireless terminal sent by the network terminal and sends the converted request to the wireless terminal.

It can be known from the above that, the remote server provided in the present document sends the request for acquiring the parameter information of the wireless terminal to the wireless terminal, and the wireless terminal sends the corresponding parameter information in the MIB preset in the wireless terminal to the remote server according to the request sent by the remote server, thus the wireless terminal can send its own usage and configuration status to the remote server, such that a network administrator can learn the usage and configuration status of the wireless terminal through the remote server, and then to make statistics and analysis on status of the wireless terminal logging on the network through the remote server, thereby implementing the management by the remote server for the wireless terminal.

### BRIEF DESCRIPTION OF DRAWINGS

FIG. 1 is a schematic diagram of an implementation flow of a method for a remote server managing a wireless terminal according to the example 1 of the present document.

FIG. 2 is a schematic diagram of a structure of an extended OID in an MIB used by the present document.

FIG. 3 is a schematic diagram of an implementation flow of a method for a remote server managing a wireless terminal according to the example 2 of the present document.

FIG. 4 is a schematic diagram of an implementation flow of another method for a remote server managing a wireless terminal according to the example of the present document.

FIG. 5 is a schematic diagram of information transmission between a network terminal, wireless terminal and remote server when the wireless terminal is in a log-in network state.

FIG. 6 is a schematic diagram of an implementation flow of another method for a remote server managing a wireless terminal according to the example of the present document.

FIG. 7 is a schematic diagram of information transmission between a network terminal, wireless terminal and remote server in a case that offline setting and online setting are in synchronization.

FIG. 8 is a schematic diagram of a composition structure of a remote server according to one example of the present document.

FIG. 9 is a schematic diagram of a composition structure of an acquisition request sending unit of the remote server according to one example of the present document.

FIG. 10 is a schematic diagram of a composition structure of a wireless terminal according to one example of the present document.

FIG. 11 is a schematic diagram of a composition structure of a system for the remote server managing the wireless terminal according to one example of the present document.

### PREFERRED EMBODIMENTS OF THE INVENTION

In considering that an MIB is set in a wireless terminal, a remote server and the wireless terminal can perform a data transmission through a Simple Network Management Protocol (SNMP). Therefore, with respect to three status of the remote server managing the wireless terminal, the present document discloses three corresponding methods for the remote server managing the wireless terminal: one method is the remote server actively acquiring parameter information of the wireless terminal; another method is the remote server setting parameter information on the wireless terminal according to a request of the wireless terminal; a further method is the wireless terminal setting parameter information within a local Node Value (NV) when it is offline, and the remote server setting parameter information within an MIB of the wireless terminal according to the parameter information within the NV when it is online.

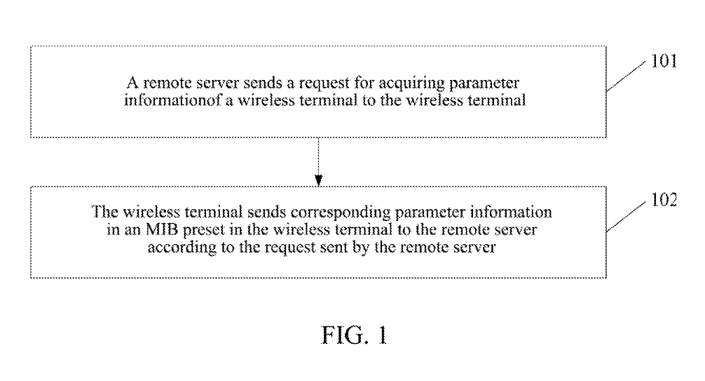

An implementation flow of one method for a remote server managing a wireless terminal according to the example 1 of the present document is as shown in FIG. 1, and the method includes the following steps.

In step 101, the remote server sends a request for acquiring parameter information of the wireless terminal to the wireless terminal.

Specifically, the remote server can send the request for acquiring the information of the wireless terminal to the wireless terminal according to a set time interval. For example, the remote server sends a bulk-request message for acquiring the information of the wireless terminal to the wireless terminal every minute.

The remote server also can send the request for acquiring the information of the wireless terminal to the wireless terminal according to a received acquisition command. For example, when a network administrator needs to acquire certain parameter information of the wireless terminal according to actual management conditions, the network administrator sends the acquisition command to the remote server, and the remote server sends the request for acquiring the information of the wireless terminal to the wireless terminal according to the received acquisition command.

In step 102, the wireless terminal sends corresponding parameter information in an MIB preset in the wireless terminal to the remote server according to the request sent by the remote server.

In the step, when the wireless terminal is in a log-in network state, an snmp-agent process on the wireless terminal will operate, the process can monitor a port 161 of a local User Datagram Protocol (UDP) and receive a get-request message for acquiring the information of the wireless terminal; then, the snmp-agent process will send the corresponding parameter information in the MIB preset in the wireless terminal to the remote server in a form of SNMP-response.

Here, the MIB is an information base provided by the wireless terminal for accessing by the remote server and is composed of a plurality of OIDs. The OIDs are divided into a standard OID and an extended OID, wherein, the standard OID is used for configuring universal parameter information of the wireless terminal, and the standard OID includes: a system identifier (system), an interface (if), address translation (at), ip, icmp and tcp and so on. The extended OID is obtained through custom, and the extended OID is used for configuring non-universal parameter information of the wireless terminal.

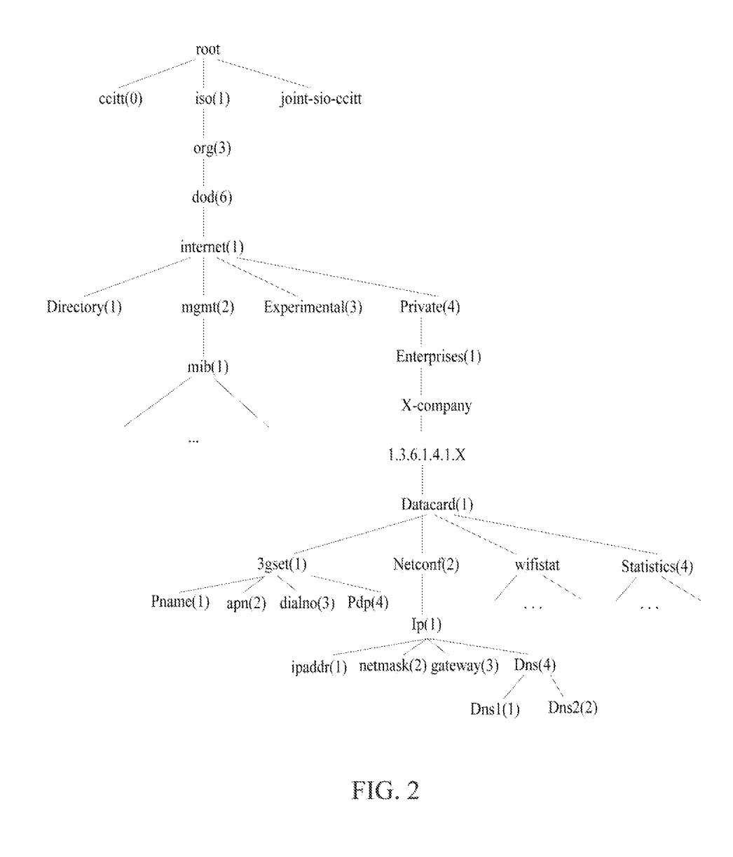

As shown in FIG. 2, an OID whose location is 1.3.6.1.4.1.x is an extended OID, and leaf nodes 3gnet, netconf, Wifistat and statistics below the extended OID and sub-leaf nodes corresponding to the above leaf nodes are all extended OIDs. The extended OID stores the non-universal parameter information of the wireless terminal to adapt to different data cards or MiFi products. For example, an extended OID whose location is 1.3.6.1.4.1.x.1.2.1.4.1 stores an address dns1 of the wireless terminal, and an extended OID whose location is 1.3.6.1.4.1.x.1.1.2 stores an address apn of the wireless terminal.

It can be known from the above that, the wireless terminal can send the corresponding parameter information in the MIB preset in the wireless terminal to the remote server according to the request sent by the remote server. Therefore, the network administrator can know configuration and operation status of the wireless terminal through the remote server and then make statistics and analysis on status of the wireless terminal logging on the network, and it also can configure and manage the wireless terminal at the same time.

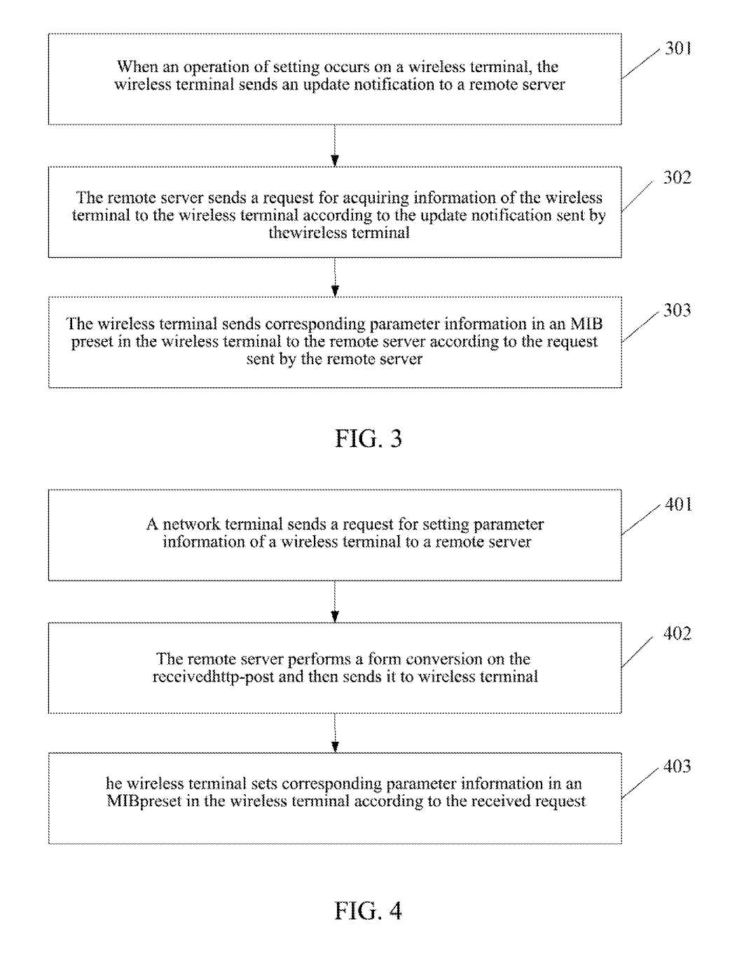

An implementation flow of a method for a remote server managing a wireless terminal according to the example 2 of the present document is as shown in FIG. 3, and the method includes the following steps.

In step 301, when an operation of setting occurs on the wireless terminal, the wireless terminal sends an update notification to the remote server.

Here, the operation of setting can be traffics reaching a preset value. For example, the traffics in a unit time of the wireless terminal reach the preset value, and the wireless terminal sends a trap message in an SNMP format to the remote server.

In step 302, the remote server sends a request for acquiring information of the wireless terminal to the wireless terminal according to the update notification sent by the wireless terminal.

In step 303, the wireless terminal sends corresponding parameter information in an MIB preset in the wireless terminal to the remote server according to the request sent by the remote server.

It can be known from the above that, when the operation of setting occurs on the wireless terminal, the wireless terminal sends the update notification to the remote server. Therefore, a network administrator can know configuration and operation status of the wireless terminal in time through a remote terminal. For example, when a computer corresponding to the wireless terminal suffers an attack from the network virus, the network administrator can configure and manage the wireless terminal in time through the remote server, which prevents the computer of the user from suffering losses.

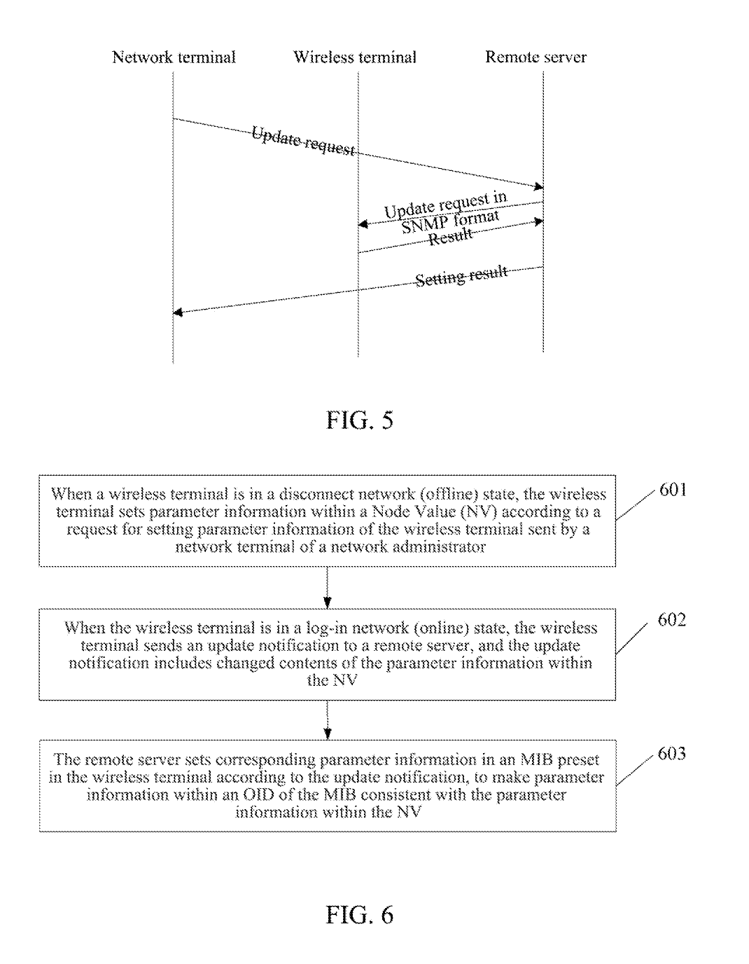

An implementation flow of another method for a remote server managing a wireless terminal according to the example of the present document may refer to FIG. 4 and FIG. 5, and the method includes the following steps.

In step 401, a network terminal sends a request for setting parameter information of the wireless terminal to the remote server.

In the step, when the wireless terminal is in a log-in network state, a network administrator or a user can open a web configuration page of the remote server through the network terminal (e.g. a computer) to perform a remote access, and send an update request (i.e. http-post) for setting the parameter information of the wireless terminal.

In step 402, the remote server performs a form conversion on the received http-post and then sends it to wireless terminal.

Here, since the data transmission between the network terminal and the remote server is performed through a HyperText Transfer Protocol (HTTP) and the data transmission between the remote server and wireless terminal is performed through an SNMP, the remote server is required to convert the received request http-post to an update request in an SNMP format and send the request to the wireless terminal.

In step 403, the wireless terminal sets corresponding parameter information in an MIB preset in the wireless terminal according to the received request.

After the setting is completed, the wireless terminal sends result information in the SNMP format to the remote server, and the remote server send set-result information in an HTTP format to the network terminal according to the result information, which means that the setting at this time is completed.

It can be known from the above that, the network administrator or user can set the parameter information of the wireless terminal through the remote server. Therefore, a remote terminal can configure and manage the wireless terminal.

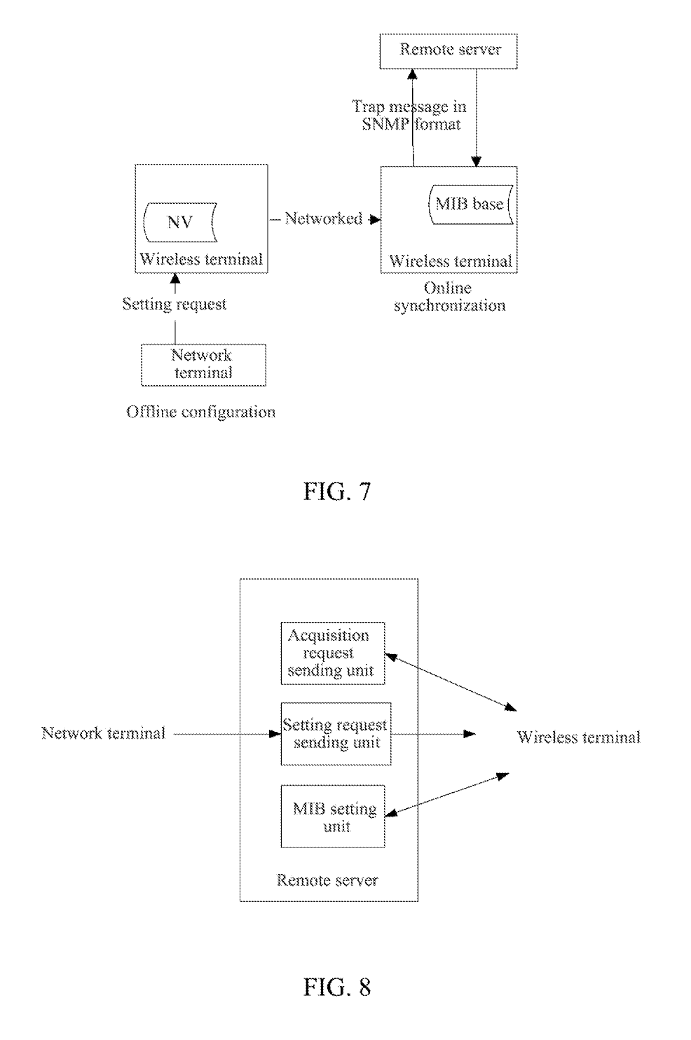

An implementation flow of another method for a remote server managing a wireless terminal according to the example of the present document may refer to FIG. 6 and FIG. 7, and the method includes the following steps.

In step 601, when the wireless terminal is in a disconnect network (offline) state, the wireless terminal sets parameter information within a Node Value (NV) according to a request for setting parameter information of the wireless terminal sent by a network terminal of a network administrator.

Specifically, when the wireless terminal is in the disconnect network state, a user can open a web configuration page of an embedded web server of the wireless terminal in a Local Area Network (LAN) through the network terminal (e.g. a computer), the web configuration page is consistent with a web configuration page of the remote server when the wireless terminal is in a log-in network state, but the configuration page of the embedded web server is in local, and the web configuration page of the remote server is at a remote end. The wireless terminal sets the parameter information within the NV according to a setting request (http-set) for setting the parameter information of the wireless terminal sent by the network terminal. Changes of the parameter information of the wireless terminal will be saved in flash of the wireless terminal.

In step 602, when the wireless terminal is in the log-in network (online) state, the wireless terminal sends an update notification to the remote server, and the update notification includes changed contents of the parameter information within the NV.

Specifically, when the wireless terminal logs on the network, the wireless terminal can send the update notification to the remote server. For example when the wireless terminal logs on the network, the wireless terminal sends a trap message in an SNMP format as the update notification to a port 162 of the remote server.

In step 603, the remote server sets corresponding parameter information in an MIB preset in the wireless terminal according to the update notification, to make parameter information within an OID of the MIB consistent with the parameter information within the NV.

It can be known from the above that, the user can set the parameter information of the wireless terminal when the wireless terminal is in the disconnect network (offline) state. Therefore, the user setting the parameter information of the wireless terminal will not be limited by whether the wireless terminal logs on the network or not, which is convenient for the user to operate, and a remote terminal can also configure and manage the wireless terminal.

In order to implement the above method, the present document provides a remote server, and as shown in FIG. 8, the remote server includes:

an acquisition request sending unit, configured to: send a request for acquiring parameter information of a wireless terminal to the wireless terminal;

a setting request sending unit, configured to: perform a form conversion on a request for setting the parameter information of the wireless terminal sent by a network terminal and send it to the wireless terminal;

an MIB setting unit, configured to: set corresponding parameter information in an MIB preset in the wireless terminal according to an update notification sent by the wireless terminal, to make parameter information within an OID of the MIB consistent with parameter information within an NV.

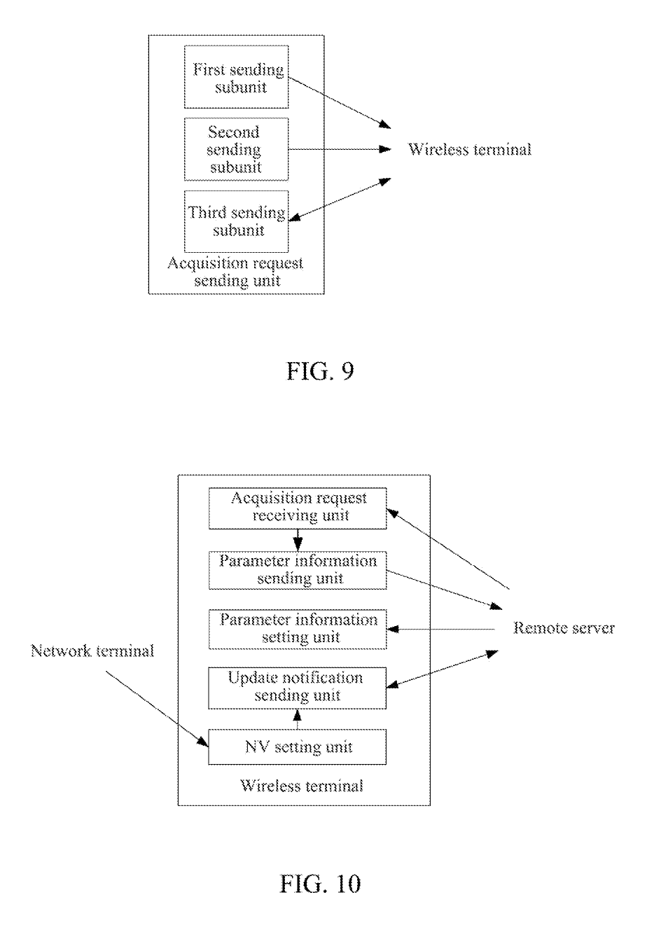

As shown in FIG. 9, the acquisition request sending unit includes:

a first sending unit, configured to: send the request for acquiring the information of the wireless terminal to the wireless terminal according to a set time interval;

a second sending unit, configured to: send the request for acquiring the information of the wireless terminal to the wireless terminal according to a received acquisition command;

a third sending unit, configured to: send the request for acquiring the information of the wireless terminal to the wireless terminal according to the update notification sent by the wireless terminal.

The present document also provides a wireless terminal, and as shown in FIG. 10, the wireless terminal includes: an acquisition request receiving unit and a parameter information sending unit, wherein,

the acquisition request receiving unit is configured to: receive an acquisition request sent by a remote server;

the parameter information sending unit is configured to: send corresponding parameter information in an MIB preset in the wireless terminal to the remote server according to the acquisition request sent by the remote server.

The wireless terminal also includes: an update notification sending unit, configured to send an update notification to the remote server when an operation of setting occurs on the wireless terminal.

The wireless terminal also includes: a parameter information setting unit, configured to set the corresponding parameter information in the MIB preset in the wireless terminal according to a received request;

The remote server performs a form conversion on a received request for setting parameter information of the wireless terminal sent by a network terminal and sends it to the wireless terminal.

The wireless terminal also includes: an NV setting unit, configured to: when the wireless terminal is in a disconnect network state, according to the request for setting the parameter information of the wireless terminal sent by the network terminal, set parameter information within a Node Value (NV);

the update notification sending unit is further configured to: when the wireless terminal is in a log-in network state, send an update notification to the remote server, wherein the update notification includes changed contents of the parameter information within the NV.

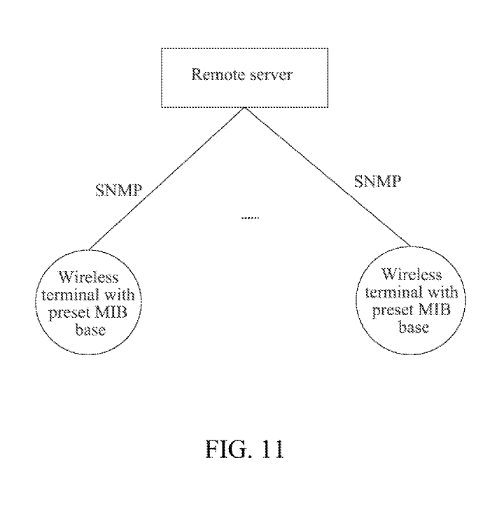

The present document also provides a system for a remote server managing a wireless terminal, and as shown in FIG. 11, the system includes: the remote server and at least one wireless terminal.

The remote server is configured to: send a request for acquiring parameter information of the wireless terminal to the wireless terminal; perform a form conversion on a request for setting the parameter information of the wireless terminal sent by a network terminal and send it to the wireless terminal; and set corresponding parameter information in an MIB preset in the wireless terminal according to an update notification sent by the wireless terminal, to make parameter information within an OID of the MIB consistent with parameter information within an NV.

The wireless terminal is configured to: receive an acquisition request sent by the remote server; and send the corresponding parameter information in the MIB preset in the wireless terminal to the remote server according to a received acquisition request.

Alternatively, the wireless terminal is further configured to: when an operation of setting occurs, send the update notification to the remote server.

Alternatively, the wireless terminal is further configured to: set the corresponding parameter information in the MIB preset in the wireless terminal according to a received request; the remote server performs a form conversion on a received request for setting parameter information of the wireless terminal sent by a network terminal and sends it to the wireless terminal.

The present document is applied to wireless terminals such as data cards or MiFi products in various systems, and the systems can include: Time Division-Synchronous Code Division Multiple Access (TD-SCDMA), Wideband Code Division Multiple Access (WCDMA), CDMA2000, Worldwide Interoperability for Microwave Access (WIMAX), Long Term Evolution (LTE) and High Speed Downlink Packet Access (HSDPA) and so on.

The above description is only the preferred examples of the present document, which is not used to limit the protection scope of the present document.

1. A method for a remote server managing a wireless terminal, comprising:
the remote server sending a request for acquiring parameter information of the wireless terminal to the wireless terminal;
the wireless terminal sending corresponding parameter information in a Management Information Base (MIB) preset in the wireless terminal to the remote server according to the request sent by the remote server.

2. The method according to claim 1, wherein, the remote server sending a request for acquiring information of the wireless terminal to the wireless terminal is:
the remote server sending the request for acquiring the information of the wireless terminal to the wireless terminal according to a set time interval;
or, the remote server sending the request for acquiring the information of the wireless terminal to the wireless terminal according to a received acquisition command.

3. The method according to claim 1, wherein, before the step of the remote server sending a request for acquiring information of the wireless terminal to the wireless terminal, the method further comprises:
when an operation of setting occurs on the wireless terminal, the wireless terminal sending an update notification to the remote server;
correspondingly, the remote server sending a request for acquiring information of the wireless terminal to the wireless terminal is: the remote server sending the request for acquiring the information of the wireless terminal to the wireless terminal according to the update notification sent by the wireless terminal.

4. The method according to claim 1, wherein, the MIB comprises:
a standard Object Identifier (OID) and an extended OID.

5. (canceled)

6. A method for a remote server managing a wireless terminal, comprising:
when the wireless terminal is in a disconnect network state, the wireless terminal setting parameter information within a Node Value (NV) according to a request for setting parameter information of the wireless terminal sent by a network terminal;
when the wireless terminal is in a log-in network state, the wireless terminal sending an update notification to the remote server, and the update notification carrying changed contents of the parameter information within the NV;
the remote server setting corresponding parameter information in an MIB preset in the wireless terminal according to the update notification, to make parameter information within an OID of the MIB consistent with the parameter information within the NV.

7. The method according to claim 6, wherein, the wireless terminal sending an update notification to the remote server is: when the wireless terminal logs on a network, the wireless terminal sending the update notification to the remote server.

8.-9. (canceled)

10. A wireless terminal, comprising: an acquisition request receiving unit and a parameter information sending unit, wherein,
the acquisition request receiving unit is configured to: receive an acquisition request sent by a remote server;
the parameter information sending unit is configured to: send corresponding parameter information in an MIB preset in the wireless terminal to the remote server according to a received acquisition request.

11. The wireless terminal according to claim 10, wherein, the wireless terminal further comprises:
an update notification sending unit, configured to: when an operation of setting occurs on the wireless terminal, send an update notification to the remote server.

12. The wireless terminal according to claim 10, wherein, the wireless terminal further comprises:
a parameter information setting unit, configured to: set the corresponding parameter information in the MIB preset in the wireless terminal according to a received request;
the remote server performs a form conversion on a received request for setting parameter information of the wireless terminal sent by a network terminal to send to the wireless terminal.

13. The wireless terminal according to claim 10, wherein, the wireless terminal further comprises:
an NV setting unit, configured to: when the wireless terminal is in a disconnect network state, according to the request for setting the parameter information of the wireless terminal sent by the network terminal, set parameter information within a Node Value (NV);
the update notification sending unit is further configured to: when the wireless terminal is in a log-in network state, send an update notification to the remote server, and the update notification includes changed contents of the parameter information within the NV.

14.-16. (canceled)
